(19) United States
(12) Patent Application Publication
(10) Pub. No.: US 2004/0246923 A1
(43) Pub. Date: Dec. 9, 2004

(54) Method for cell change in a packet-mode cellular mobile radiocommunication system

(76) Inventor: Jacques Achard, Les Moulineaux (FR)

Correspondence Address: Sughrue Mion, Suite 800, 2100 Pennsylvania Avenue NW, Washington, DC, 20037-3213, US

(21) Appl. No.: 10/496,511

(22) PCT Filed: Nov. 22, 2002
(86) PCT No.: PCT/FR02/04023

(30) Foreign Application Priority Data
Nov. 23, 2001 (FR) 01/15228

(51) Int. Cl. H04Q 7/00

(52) U.S. Cl. 370/331; 370/436

(57) ABSTRACT

A cell changing method for a packet-mode cellular mobile radio system, in which method information relating to resources allocated to a mobile station in a new cell is signaled by the network to said mobile station when said mobile station is still in the old cell and information intended to enable the mobile station to determine a timing advance to be applied by said mobile station in the new cell is also signaled by the network to said mobile station when said mobile station is still in the old cell.

The present invention relates generally to mobile radio systems.

A distinction is generally made in these systems between circuit-mode services, which are designed primarily for traffic sensitive to routing delays (such as speech in particular), but in which bandwidth use is not optimized, and packet-mode services, which are designed primarily for traffic that is not very sensitive to routing delays (such as data transfer in particular), but in which bandwidth use is more optimized.

One example of a mobile radio system is the Global System for Mobile communications (GSM), initially developed primarily for telephony, to which the General Packet Radio System (GPRS) was subsequently added to offer packet-mode services.

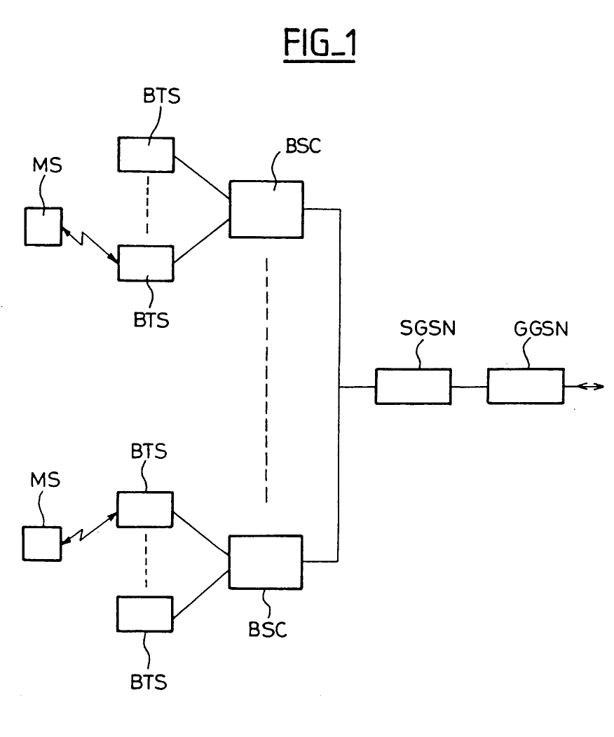

FIG. 1 outlines the architecture of packet-mode systems such as GSM/GPRS systems, for example, which essentially comprises:

base transceiver stations (BTS) communicating with mobile stations (MS) and base transceiver station controllers (BSC), the combination of the BTS and the BSC being called the base transceiver station subsystem (BSS) or, more generally, the radio access network (RAN), and

entities such as serving GPRS support node (SGSN) entities communicating with the BSS and with gateway GPRS support node (GGSN) entities, which in turn communicate with external networks (not shown), the combination of the SGSN and the GGSN being called the network subsystem (NSS) or, more generally, the core network (CN).

The BSS covers functions common to circuit-mode services and packet-mode services and functions specific to packet-mode services; the latter are supported by a particular entity of the BSS called the packet control unit (PCU) that is not specifically shown in FIG. 1.

For a detailed description of a system of this kind see the corresponding specifications published by the corresponding standardization organizations.

These systems generally have a cellular architecture and techniques are provided for changing cell during a, call. A distinction is usually made between the handover (intercellular transfer) techniques used in circuit mode and the cell reselection techniques used in packet mode. Briefly, while handover techniques necessitate advance reservation of resources in the new cell (target cell) before requesting the mobile station to connect to the new cell, cell reselection techniques do not necessitate any such advance reservation of resources, the mobile station submitting a resource reservation request when it accesses the reselected new cell (target cell).

A distinction is generally made between cell reselection control modes corresponding to decreasing degrees of autonomy of the mobile station (or to increasing degrees of control by the network, which amounts to the same thing).

In the case of the GSM/GPRS system, for example, as specified in the 3GPP Technical Specifications TS 05.08 and TS 04.60 published by the 3^{rd} Generation Partnership Project (3GPP):

in a first control mode NC0, the mobile station decides autonomously to effect a transfer of this kind and itself selects the target cell to which the call is to be transferred, taking account of the results of measurements that it carries out,

in a second control mode NC1, the mobile station decides autonomously to effect a transfer of this kind and itself selects the target cell to which the call is to be transferred, taking account of the results of measurements that it carries out, and also sends the measurement results to the network,

in a third control mode NC2, the network decides to effect a transfer of this kind and selects the target cell to which the call is to be transferred, taking account of measurement results that the mobile station sends it.

The NC2 control mode is also called cell reselection controlled by the network. In this case, the network, instructs the mobile station to perform cell reselection in a Packet Cell Change Order message containing the identity of the reselected cell.

The NC0 and NC1 control modes correspond to cell reselection controlled by the mobile station. In this case, the mobile station decides on cell reselection itself.

Moreover, in packet mode, once the mobile station has determined a target cell or the network has imposed a target cell, according to one or the other of the above control modes, the mobile station must carry out a set of operations to connect to the target cell, as described in particular in the 3GPP Technical Specification TS 44.060.

A first operation entails the mobile station acquiring certain necessary system information broadcast on a common channel in the target cell.

A second operation consists in carrying out a procedure for access to the target cell.

It is possible to use either of two methods called the single-phase access method and the two-phase access method to initialize data transfer by a mobile station or to set up a temporary block flow (TBF) at the initiative of a mobile station.

Briefly, in the single-phase access method the network responds to a request from the mobile station with a message indicating directly to the mobile station the resources that have been allocated.

In the two-phase access method the network responds to a request from the mobile station with a message indicating to the mobile station a limited resource that it may use to send a message containing a more precise description of its requirements, the network then responding with a message indicating the resources that have been allocated.

Furthermore, in either method, if the mobile station does not obtain a response from the network within a predetermined time, it may repeat the request.

A third operation entails the mobile station obtaining a timing advance to be applied to signals sent by the mobile station in the target cell, relative to signals received. It must be remembered that in a system using a time division multiple access (TDMA) technique, such as the GSM/GPRS system in particular, the signals sent are structured into frames comprising time slots that may be allocated to different users. Applying a timing advance to a signal sent by a mobile station is intended to compensate the propagation time of that signal between the mobile station and the base transceiver station, so that the signal is received at the base transceiver station within the time slot allocated for its transmission, independently of the propagation time.

This third operation generally comprises the following steps:

the mobile station sends the new base transceiver station signals called access bursts having a sufficiently short duration not to interfere with adjacent time slots,

the base transceiver station evaluates the propagation time of these signals by comparing their send and receive times,

the new base transceiver station sends the mobile station the propagation time determined in this way and to be used in the new cell (i.e. the timing advance to be used in the new cell).

Once the mobile station has received the timing advance to be used in the new cell, transfer may finally resume in the new cell. The value of the timing advance may then be adjusted during transmission in the target cell.

It is apparent that procedures of this kind are relatively lengthy and are therefore liable to increase significantly the duration of the interruption in the transfer caused by the cell change. Although this is acceptable for certain types of traffic, for which the packet mode was in fact initially designed, a problem arises because packet mode is now increasingly used for certain types of traffic for which the time delay constraints, although not so severe as those of circuit mode, are nevertheless demanding. For example, applications in which the transport protocol used on the GPRS network is of the Transmission Control Protocol/Internet Protocol (TCP/IP) type suffer from significantly degraded performance in terms of bit rate caused by relatively short traffic interruptions (with a duration of the order of one second). For applications of this kind, any such increase in the transfer interruption time may be considered to degrade the quality of service unacceptably.

A first solution that has been proposed entails introducing a network assisted cell change (NACC) mode, as described in particular in the 3GPP Technical Specification TS 44.060. A solution of this kind in particular enables the mobile station to acquire the necessary system information relating to the target cell more quickly, and in this instance to acquire the information before quitting the serving cell, the network sending this information to the mobile station on a dedicated signaling channel.

A second solution that has been proposed entails using principles similar to those used in the handover techniques employed for circuit-mode services, namely reservation of resources in the target cell when the mobile station is still in the serving cell. The resources allocated to the mobile station in the target cell may be communicated to the mobile station in the serving cell in a message such as the Packet Cell Change Order message or the Packet Time Slot Reconfigure message, as defined in the 3GPP Technical Specification TS 44.060. See in particular the following documents:

EP 1059820,

WO 00/79808,

3GPP TSG GERAN WG2#6bis, Aix-en-Provence, France, March 22^{nd}-26^{th}, 2001, Tdoc GERAN G2 010387 Agenda item 7.2.5.6.

This second solution reduces the time for which transfer is interrupted more efficiently than the first solution. However, this second solution, as described in the above documents, implies that the mobile station must acquire the timing advance relating to the target cell from the network using the access burst technique referred to above, before resuming the transfer in the target cell. Now any such technique, comprising the various steps outlined above in connection with the operation referred to as the third operation, significantly increases the time for which transfer is interrupted. The last of the above documents indicates, incidentally, that, because of this, the time for which transfer is interrupted may not be further reduced.

A particular object of the present invention is to avoid some or all of the above problems. A more general object of the invention is to improve the performance of such systems.

One object of the present invention is to reduce further the time for which transfer is interrupted in a packet-mode mobile radio system because of the cell change.

One aspect of the present invention provides a cell changing method for a packet-mode cellular mobile radio system, in which method information relating to resources allocated to a mobile station in a new cell is signaled by the network to said mobile station when said mobile station is still in the old cell and information intended to enable the mobile station to determine a timing advance to be applied by said mobile station in the new cell is also signaled by the network to said mobile station when said mobile station is still in the old cell.

Another aspect of the present invention provides a mobile station for a packet-mode cellular mobile radio system, said station comprising:

means for receiving from the network information sent by an old cell and indicating that the real time difference RTD between the old cell and the new cell is equal to zero, and

means for determining a timing advance value TA1 to be used in the new cell from a measured observed time difference OTD between the new cell and the old cell and a timing advance value TA0 used in the old cell, using the equation TA1=OTD+TA0.

According to another feature of the invention, said information indicating that the real time difference RTD between the old cell and the new cell is equal to zero is sent in a message allocating resources to the mobile station in the new cell.

A further aspect of the present invention provides a mobile station for a packet-mode cellular mobile radio system, said station comprising:

means for receiving from the network information sent by the old cell and comprising the real time difference RTD between an old cell and a new cell,

means for determining a timing advance value TA1 to be used in the new cell from a measured observed time difference OTD between the new cell and the old cell, a timing advance value TA0 used in the old cell, and said real time difference RTD sent by the old cell, using the equation TA1=OTD−RTD+TA0.

According to another feature of the invention, said real time difference RTD between the old cell and the new cell is sent in a message allocating resources to the mobile station in the new cell.

A further aspect of the present invention provides a mobile station for a packet-mode cellular mobile radio system, said station comprising:

means for receiving from the network a timing advance value TA1 sent by an old cell and to be used in a new cell.

According to another feature of the invention, said timing advance value TA1 to be used in the new cell is sent in a message allocating resources to the mobile station in the new cell.

A further aspect of the present invention provides packet-mode cellular mobile network equipment comprising:

means for an old cell to send to a mobile station information intended to indicate that the real time difference RTD between the old cell and a new cell is equal to zero.

According to another feature of the invention, said information intended to indicate that the real time difference RTD between the old cell and the new cell is equal to zero is sent in a message allocating resources to the mobile station in the new cell.

A further aspect of the present invention provides packet-mode cellular mobile network equipment comprising:

means for an old send cell to send to a mobile station information comprising the real time difference RTD between the old cell and a new cell.

According to another feature of the invention, said real time difference RTD between the old cell and the new cell is sent in a message allocating resources to the mobile station in the new cell.

A further aspect of the present invention provides packet-mode cellular mobile radio network equipment comprising:

means for an old cell to send to a mobile station information comprising a timing advance value TA1 to be used in a new cell.

According to another feature of the invention, said timing advance to be used in the new cell is sent in a message allocating resources to the mobile station in the new cell.

A further aspect of the present invention provides a packet-mode cellular mobile radio system mobile station comprising:

means for communicating to the network information intended to enable the network to acquire a real time difference RTD between an old cell and a new cell.

According to another feature of the invention, said information includes a measured observed time difference OTD between the new cell and the old cell and a timing advance value used in the old cell and sent to the network by the mobile station in the new cell.

According to another feature of the invention, said information is sent in a first acknowledgement message sent to the network by the mobile station in the new cell.

According to another feature of the invention, said information is sent in a message sent in a first uplink block sent to the network by the mobile station in the new cell.

According to another feature of the invention, said information is sent in a cell update message sent to the network by the mobile station in the new cell.

A further aspect of the present invention provides packet-mode cellular mobile radio network equipment comprising:

means for receiving from a mobile station information intended to enable the network to acquire information comprising a real time difference RTD between an old cell and a new cell.

According to another feature of the invention, said information includes a measured observed time difference OTD between the new cell and the old cell and a timing advance value used in the old cell and sent to the network by the mobile station in the new cell.

According to another feature of the invention, said information is sent in a first acknowledgement message sent to the network by the mobile station in the new cell.

According to another feature of the invention, said information is sent in a message sent in a first uplink block sent to the network by the mobile station in the new cell.

According to another feature of the invention, said information is sent in a cell update message sent to the network by the mobile station in the new cell.

A further aspect of the present invention provides a packet-mode cellular mobile radio system comprising at least one mobile station according to the invention.

A further aspect of the present invention provides a packet-mode cellular mobile radio system comprising at least one network equipment according to the invention.

Other objects and features of the present invention will become apparent on reading the following description of embodiments of the invention, which is given with reference to the appended drawings, in which:

FIG. 1 (already described) is a diagram outlining the general architecture of a GPRS cellular mobile radio system, and

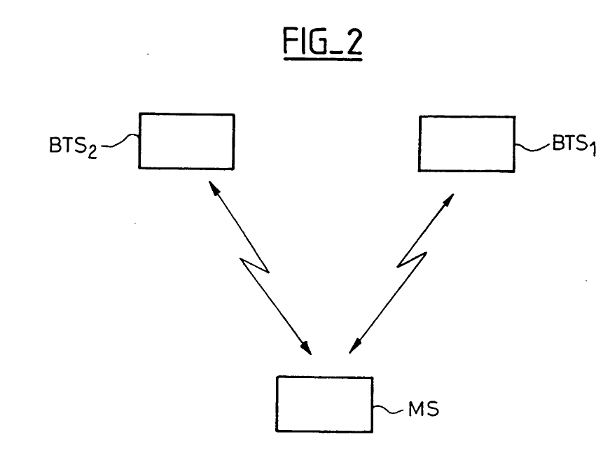

FIG. 2 is a diagram depicting the theory of synchronized handover and pseudosynchronized handover.

For packet mode, the invention suggests using principles similar to those developed for circuit mode, using the synchronized, presynchronized and pseudosynchronized handover techniques defined in particular in 3GPP Technical Specification TS 05.10.

The theory of pseudosynchronized handover is outlined first, with reference to FIG. 2, which shows a mobile station MS and two base transceiver stations, of which the station BTS0 corresponds to a serving cell and the station BTS1 corresponds to a target cell. The present application uses interchangeably the terms new cell and new base transceiver station, on the one hand, and the terms old cell and old base transceiver station, on the other hand.

As a general rule, if the base transceiver stations are not synchronized, it is necessary to take account not only of a propagation time difference between the old and new base transceiver stations but also of a synchronization offset between the two stations.

In the most general case:

OTD=RTD+t1−t0

where:

OTD is the observed time difference perceived by the mobile station MS listening simultaneously to the base transceiver stations BTS0 and BTS1,

RTD is the real time difference between the base transceiver stations BTS0 and BTS1, also called the synchronization offset between the base transceiver stations, and

t0 is the propagation time between MS and BTS0 and t1 is the propagation time between MS and BTS1 (so that t1−t0 is the propagation time difference for the two base transceiver stations).

The theory of pseudosynchronized handover is based on the fact that a mobile station may determine the propagation time t1 (and therefore the timing advance to be applied in the new cell) from values of OTD and t0 known to the mobile station and a value of RTD acquired by the network and communicated to the mobile station in the serving cell.

Furthermore, the network may acquire the RTD value from OTD and to values communicated by the mobile station to the new base transceiver station BTS1 immediately after handover and a t1 value determined by the base transceiver station BTS1 immediately after handover. Other methods of acquiring or estimating an RTD value are possible, of course.

The situation of synchronized handover corresponds to the particular situation of base transceiver stations BTS0 and BTS1 that are synchronized. In this particular case, RTD is equal to zero.

It must also be remembered that the theory of presynchronized handover is based on the fact that the old cell may have an a priori knowledge of the timing advance TA1 to be applied in the new cell, for example because of a particular geographical position of the old and new cells. For example, if the old cell is a microcell and the new cell is a corresponding umbrella macrocell, the base transceiver station BTSO is able to supply a good estimate of the timing advance value TA1 to be used in the target cell. Another situation that may arise is handover to a microcell in which a zero value of TA1 may be used initially, because of the small size of the cell.

The following embodiments of the invention are proposed:

For Synchronized TBF Handover:

RTD is equal to zero. The mobile station MS may calculate the timing advance TA1 from TA0 (the timing advance used in the old cell) and OTD, which it measures, and use TA1 immediately in the new cell.

The information indicating that the TBF handover is synchronized or that RTD is equal to zero, which amounts to the same thing, may be sent to the mobile station MS by the base transceiver station BTS0 as an optional item of information in a message allocating resources to the mobile station MS in the new cell, for example one of the following messages:

Packet Uplink Assignment (PUA),

Packet Downlink Assignment (PDA),

Packet Timeslot Reconfigure (PTR),

Packet Cell Change Order (PCCO).

If the optional information is not included, then the synchronized TBF handover procedure is not applied, and the mobile station MS uses the existing procedures. If the information is present, the mobile station MS may calculate TA1 and use it immediately in the new cell.

For Pseudosynchronized TBF Handover:

RTD may be sent to the mobile station MS by the base transceiver station BTS0 as an optional item of information in the message allocating resources to the mobile station MS in the new cell, for example one of the following messages:

Packet Uplink Assignment (PUA),

Packet Downlink Assignment (PDA),

Packet Timeslot Reconfigure (PTR),

Packet Cell Change Order (PCCO).

If the optional information is not included, then the pseudosynchronized TBF handover procedure is not applied, and the mobile station MS uses the existing procedures. If the information is present, the mobile station MS may calculate TA1 and use it immediately in the new cell.

Moreover, the mobile station MS may communicate OTD+TA0 to the base transceiver station BTS1, for example in the first Packet Downlink Ack/Nack (PDAN) acknowledgement message sent to the base transceiver station BTS1 in the case of downlink transfer (DL TBF), and for example in the first uplink block sent to the base transceiver station BTS1 in the case of uplink transfer (UL TBF) (this requires a new message to be defined, for example by modifying the existing Packet Measurement Report message). For the downlink direction, another solution does not use the PDAN message: because, even for a downlink transaction, the mobile station MS must effect a cell update at some time via an uplink TBF in the new cell, OTD+TA0 could be sent in an uplink block (UL block) in this case also (for example in a modified Packet Measurement Report message).

For Presynchronized TBF Handover:

TA1 may be sent to the mobile station MS by the base transceiver station BTS0 as an optional item of information in the message allocating resources to the mobile station MS in the new cell, for example one of the following messages:

Packet Uplink Assignment (PUA),

Packet Downlink Assignment (PDA),

Packet Timeslot Reconfigure (PTR),

Packet Cell Change Order (PCCO).

If the optional information is not included, then the presynchronized TBF handover is not applied and the mobile station MS uses the existing procedures. If the information is present, the mobile station MS may calculate TA1 and use it immediately in the new cell.

The advantages of the present invention include:

for a downlink TBF (DL TBF), the mobile station MS may acknowledge immediately the downlink blocks (DL blocks) that it receives in the new cell; there is no need for the mobile station MS to send access bursts in the new cell and no need for the network to send timing advance information to the mobile station MS via a Packet Power Control and Timing Advance (PPCTA) message; all this shortens the traffic interruption time;

for an uplink TBF (UL TBF), the mobile station MS may send valid blocks in the uplink direction immediately it is allocated uplink state flags (USF) in its new allocation in the new cell; again, there is no need for the mobile station MS to send access bursts in the new cell and no need for the network to send timing advance information to the mobile station MS via a Packet Power Control and Timing Advance (PPCTA) message. The overall improvement in terms of transfer interruption time is at least equal to the round trip delay between the MS and the packet control unit (PCU), which can be as much as 160 ms in a remote PCU architecture, for example.

The present invention also provides a mobile station, mobile radio network equipment, and a mobile radio system all comprising means adapted to implement any of the embodiments described herein of a method according to the invention.

The particular implementation of such means representing no particular problem for the person skilled in the art, such means do not need to be described in more detail than by stating their function, as above.

1. A cell changing method for a packet-mode cellular mobile radio system, in which method information relating to resources allocated to a mobile station in a new cell is signaled by the network to said mobile station when said mobile station is still in the old cell and information intended to enable the mobile station to determine a timing advance to be applied by said mobile station in the new cell is also signaled by the network to said mobile station when said mobile station is still in the old cell.

2. A mobile station for a packet-mode cellular mobile radio system, said station comprising:
means for receiving from the network information sent by an old cell and indicating that the real time difference RTD between the old cell and the new cell is equal to zero, and
means for determining a timing advance value TA1 to be used in the new cell from a measured observed time difference OTD between the new cell and the old cell and a timing advance value TA0 used in the old cell, using the equation TA1=OTD+TA0.

3. A mobile station according to claim 2, wherein said information indicating that the real time difference RTD between the old cell and the new cell is equal to zero is sent in a message allocating resources to the mobile station in the new cell.

4. A mobile station for a packet-mode cellular mobile radio system, said station comprising:
means for receiving from the network information sent by an old cell comprising the real time difference RTD between the old cell and a new cell, and
means for determining a timing advance value TA1 to be used in the new cell from a measured observed time difference OTD between the new cell and the old cell, a timing advance value TA0 used in the old cell, and said real time difference RTD sent by the old cell, using the equation TA1=OTD−RTD+TA0.

5. A mobile station according to claim 4, wherein said real time difference RTD between the old cell and the new cell is sent in a message allocating resources to the mobile station in the new cell.

6. A mobile station for a packet-mode cellular mobile radio system, said station comprising:
means for receiving from the network a timing advance value TA1 sent by an old cell and to be used in a new cell.

7. A mobile station according to claim 6, wherein said timing advance value TA1 to be used in the new cell is sent in a message allocating resources to the mobile station in the new cell.

8. Packet-mode cellular mobile network equipment comprising:
means for an old cell to send to a mobile station information intended to indicate that the real time difference RTD between the old cell and a new cell is equal to zero.

9. Network equipment according to claim 8, wherein said information intended to indicate that the real time difference RTD between the old cell and the new cell is equal to zero is sent in a message allocating resources to the mobile station in the new cell.

10. Packet-mode cellular mobile network equipment comprising:
means for an old send cell to send to a mobile station information comprising the real time difference RTD between the old cell and a new cell.

11. Network equipment according to claim 10, wherein said real time difference RTD between the old cell and the new cell is sent in a message allocating resources to the mobile station in the new cell.

12. Packet-mode cellular mobile radio network equipment comprising:
means for an old cell to send to a mobile station information comprising a timing advance value TA1 to be used in a new cell.

13. Network equipment according to claim 12, wherein said timing advance value to be used in the new is sent in a message allocating resources to the mobile station in the new cell.

14. A packet-mode cellular mobile radio system mobile station comprising:
means for communicating to the network information intended to enable the network to acquire a real time difference RTD between an old cell and a new cell.

15. A mobile station according to claim 14, wherein said information includes a measured observed time difference OTD between the new cell and the old cell and a timing advance value used in the old cell and sent to the network by the mobile station in the new cell.

16. A mobile station according to claim 14, wherein said information is sent in a first acknowledgement message sent to the network by the mobile station in the new cell.

17. A mobile station according to claim 1, wherein said information is sent in a message sent in a first uplink block sent to the network by the mobile station in the new cell.

18. A mobile station according to claim 1, wherein said information is sent in a cell update message sent to the network by the mobile station in the new cell.

19. Packet-mode cellular mobile radio network equipment comprising:
means for receiving from a mobile station information intended to enable the network to acquire information comprising a real time difference RTD between an old cell and a new cell.

20. Network equipment according to claim 19, wherein said information includes a measured observed time difference OTD between the new cell and the old cell and a timing advance value used in the old cell and sent to the network by the mobile station in the new cell.

21. Network equipment according to either claim 19, wherein said information is sent in a first acknowledgement message sent to the network by the mobile station in the new cell.

22. Network equipment according to claim 19, wherein said information is sent in a message sent in a first uplink block sent to the network by the mobile station in the new cell.

23. Network equipment according to claim 19, wherein said information is sent in a cell update message sent to the network by the mobile station in the new cell.

24. A packet-mode cellular mobile radio system comprising at least one mobile station according to claim 2.

25. A packet-mode cellular mobile radio system comprising at least one network equipment according to claim 8.
